(19) United States
(12) Patent Application Publication
(10) Pub. No.: US 2025/0340199 A1
(43) Pub. Date: Nov. 6, 2025

(54) METHOD FOR CALIBRATING FEEDBACK GAINS OF AN LQI CONTROLLER

(71) Applicants: Ningbo Geely Automobile Research & Development Co., Ltd., Ningbo (CN); Zhejiang Geely Holding Group Co., Ltd., Zhejiang (CN)

(72) Inventor: Muddassar PIRACHA, Göteborg (SE)

(21) Appl. No.: 19/260,411

(22) Filed: Jul. 4, 2025

Related U.S. Application Data
(63) Continuation of application No. PCT/CN2024/072023, filed on Jan. 12, 2024.

(30) Foreign Application Priority Data
Jan. 13, 2023 (EP) 23151473.8

(51) Int. Cl. B60W 20/40; B60K 6/24; B60K 6/26; B60K 6/387; B60K 6/442; B60W 20/17; B60W 50/00

(52) U.S. Cl. CPC B60W 20/40; B60K 6/24; B60K 6/26; B60K 6/387; B60K 6/442; B60W 20/17; B60W 50/0098; B60W 2050/0008; B60W 2050/0022; B60W 2050/0028; B60W 2050/0088; B60W 2510/0283; B60W 2710/028; B60Y 2200/92; B60Y 2300/202; B60Y 2300/426; B60Y 2400/421

(57) ABSTRACT

A method for calibrating the feedback gains of an LQI controller implemented in an electronic control unit operatively connected for controlling operation of a physical electric or electro-mechanical device of a dynamic physical system, in particular a vehicle powertrain, wherein the method of calibrating the LQI controller includes: obtaining values of various physical parameters of the dynamic physical system; inserting the obtained values of the physical parameters into predetermined equations for calculating numerical values of the individual terms of a P matrix, wherein the P matrix is the solution to the Algebraic Riccati equation, and wherein said equations include the physical parameters of the system; and calculating new feedback gains for the LQI controller based on the matrix equation

$$K = {r}^{- 1} {B}_{aug}^{T} P ,$$

based on an arbitrarily chosen positive value of r, wherein the terms of the K matrix corresponds to the feedback gains.

### RELATED APPLICATION DATA

This application is a continuation of International Patent Application No. PCT/CN2024/072023, filed Jan. 12, 2024, and claims the benefit of European Patent Application No. 23151473.8, filed Jan. 13, 2023, the disclosures of which are incorporated herein by reference in their entireties.

### TECHNICAL FIELD

The present disclosure relates to method for calibrating the feedback gains of an LQI controller. The disclosure further relates to a dynamic physical system comprising an LQI controller.

The method and system according to the disclosure can be arranged in many types of implementations over a broad technical field, where a low steady state error is required.

Moreover, even if the method and system according to the disclosure will be described primarily in relation to a hybrid electric powertrain of a car, the method and system are not restricted to this particular implementation, but may alternatively be used or installed or implemented in many other types of implementations having a controllable device, such as an electric machine, an actuator, a power generator, or the like.

### BACKGROUND

In the area of feedback controllers for controlling nearly any type of dynamic physical systems having a controllable device, the LQI controller operating based on a State Space model representing a physical system is a well-known design.

Calibration of an LQI controller is generally required upon initial start-up of the physical system, and sometimes also in connection with replacement or maintenance of system hardware, such as replacement/maintenance of actuators, motors, clutches, etc., because such replacement/maintenance may result in different values of relevant system parameters, such as inertia, damping constants, spring constants, friction, actuator speed and acceleration, etc. Calibration of the LQI controller may also be desirable in case of more temporary and/or fast variations of relevant control parameters, such as for example variations in ambient temperature, weather conditions, light conditions, road conditions, air conditions, change to a vehicle driver having a another driver profile, etc.

However, calibration of an LQI controller is generally problematic for various reasons. For example, calibration by means of manual tuning of the LQI controller based on try and error approach may be complicated and time-consuming and may result in reduced performance. Furthermore, computer aided calibration involving extensive matrix calculations may be undesirable in technical implementations having relatively low amount of memory and processing power.

It is thus desirable to provide improved calibration of an LQI controller.

### SUMMARY

The present disclosure provides a method and system where the previously mentioned problems are avoided.

According to a first aspect of the present disclosure, there is provided a method for calibrating the feedback gains of an LQI controller implemented in an electronic control unit operatively connected for controlling operation of a physical electric or electro-mechanical device of a dynamic physical system, in particular a vehicle power train, wherein the LQI controller is based on an augmented State Space model having the following form:

$$[ \begin{matrix}\dot{x} \\ ε\end{matrix} ] = {A}_{aug} x + {B}_{aug} u + [ \begin{matrix}0 \\ 1\end{matrix} ] ref \\ y = {C}_{aug} [ \begin{matrix}x \\ ε\end{matrix} ] \\ {A}_{aug} = [ \begin{matrix}A & 0 \\ - C & 0\end{matrix} ] , {B}_{aug} = {[ \begin{matrix}B & 0\end{matrix} ]}^{T} , {C}_{aug} = [ \begin{matrix}C & 0\end{matrix} ]$$

wherein the augmented State Space model is based on the following State Space model representing the physical system:

$$\dot{x} = Ax + Bu \\ y = Cx$$

wherein x is control system state vector, ε is control system tracking error, u is control system input, ref is control system target references value, y is control system output, and A, B, C represent matrices derived from a mathematical model of the dynamic physical system, and wherein the method of calibrating the LQI controller comprises: obtaining values of various physical parameters of the dynamic system; inserting the obtained values of the physical parameters into predetermined equations for calculating numerical values of the individual terms of a P matrix, wherein the P matrix is the solution to the Algebraic Riccati equation, and wherein said equations include the physical parameters of the system; and calculating new feedback gains for the LQI controller based on the matrix equation

$$K = {r}^{- 1} {B}_{aug}^{T} P ,$$

based on an arbitrarily chosen positive value of r, wherein the terms of the K matrix corresponds to the feedback gains.

According to a second aspect of the present disclosure, there is provided a dynamic physical system, in particular a vehicle power train, comprising: a physical electric or electro-mechanical device; and an electronic control unit operatively connected to the physical electric or electro-mechanical device, wherein the electronic control unit comprises an LQI controller configured for controlling operation of the physical electric or electro-mechanical device, wherein the LQI controller is based on an augmented State Space model representing the dynamic physical system, wherein the augmented State Space model may have the following form:

$$[ \begin{matrix}\dot{x} \\ ε\end{matrix} ] = {A}_{aug} x + {B}_{aug} u + [ \begin{matrix}0 \\ 1\end{matrix} ] ref \\ y = {C}_{aug} [ \begin{matrix}x \\ ε\end{matrix} ] \\ {A}_{aug} = [ \begin{matrix}A & 0 \\ - C & 0\end{matrix} ] , {B}_{aug} = {[ \begin{matrix}B & 0\end{matrix} ]}^{T} , {C}_{aug} = [ \begin{matrix}C & 0\end{matrix} ] ,$$

wherein the augmented State Space model is based on the following State Space model representing the physical system:

$$\dot{x} = Ax + Bu \\ y = Cx ,$$

wherein x is control system state vector, ε is control system tracking error, u is control system input, ref is control system target references value, y is control system output, and A, B, C represent matrices derived from a mathematical model of the dynamic physical system, wherein the electronic control unit further comprises a data memory including predetermined equations for calculating numerical values of the individual terms of a P matrix, wherein the P matrix is the solution to the Algebraic Riccati equation, and wherein said equations include the physical parameters of the system, wherein the feedback gains of the LQI controller is configured to be calibrated by: obtaining values of various physical parameters of the dynamic system; inserting the obtained values of the physical parameters into the predetermined equations for calculating numerical values of the individual terms of a P matrix; and calculating new feedback gains for the LQI controller based on the matrix equation

$$K = {r}^{- 1} {B}_{aug}^{T} P ,$$

based on an arbitrarily chosen positive value of r, wherein the terms of the K matrix corresponds to the feedback gains.

In this way, it becomes possible to perform calibration of the LQI controller with significantly less processing power, because the matrix calculations may largely be omitted, and the obtained values of the parameters may instead be inserted directly into the equations for calculating the terms for the P matrix. This enables quick and simplified calculation of the P matrix, and subsequently calculation of the new feedback gains, without having to first calculate a numerical version of for example the A matrix, and transformation of this matrix to controllable canonical form. Hence, the method for calibration of an LQI controller according to the present disclosure is particularly beneficial in technical implementations having relatively low amount of memory and processing power, such as for example vehicle implementations.

For example, if a vehicle cruise control is implemented by means of an LQI controller, the present algebraic approach for determining the feedback gains of the LQI controller based solely upon the physical parameters of the vehicle and the functional requirements of the cruise control system can be used. This would enable relatively straightforward re-calibration of the LQI controller based on for example changes in ambient conditions, such as estimated road friction coefficient. Specifically, a parameter defining a functional requirement of the cruise control, such as for example maximal allowed vehicle acceleration, may need adjustment for taking the change in road friction coefficient into account. The would be accomplished by simply calculating new feedback gains of the LQI controller using the above-defined algebraic approach, wherein one or more physical parameters defining the functional requirements of the cruise control system are adjusted to reflect the new estimated road friction coefficient.

In other words, said predetermined equations for calculating numerical values of the individual terms of a P matrix include the physical parameters defining the vehicle system and the functional requirements of the cruise control system, and the method involves {\displaystyle \det(\lambda I-A)=0} inserting updated values of the physical parameters into the predetermined equations for calculating numerical values of the individual terms of a P matrix; and calculating new feedback gains for the LQI controller based on the matrix equation

$$K = {r}^{- 1} {B}_{aug}^{T} P ,$$

This can be performed by the vehicle computer and does not require trial-and-error tuning of the feedback gains, and also not renewed calculation of the Algebraic Riccati equation because the equations for deriving the individual terms of a P matrix are predetermined and include the relevant physical parameters defining the vehicle system and functional requirements.

Further advantages are achieved by implementing one or several of the features of the dependent claims.

In some example embodiments, the P matrix is a diagonal matrix having the following form:

$$P = [ \begin{matrix}{p}_{11} & {p}_{12} & ⋯ & {p}_{1 n} \\ {p}_{12} & {p}_{22} & ⋯ & {p}_{2 n} \\ ⋮ & ⋮ & ⋯ & {p}_{3 n} \\ {p}_{1 n} & {p}_{2 n} & ⋯ & {p}_{n n}\end{matrix} ] .$$

In some example embodiments, that may be combined with any one or more of the above-described embodiments, each of the equations for calculating the terms of the P matrix is a function of not more than constants, obtainable physical parameters of the dynamic system, other terms of the P matrix, and terms of the Q matrix. In other words, the derived equations of the P matrix can be calculated based merely on physical parameters of the physical system.

In some example embodiments, that may be combined with any one or more of the above-described embodiments, the physical parameters of the dynamic system are obtained by {\displaystyle \det(\lambda I-A)=0} manually by a user that is measuring, detecting or estimating the values of the physical parameters of the dynamic system, and/or by the electronic control unit that automatically conducts measurements, detects or estimates the values of the physical parameters of the dynamic system. The calibration process may thus require some manual input, unless the system autonomously determines the required updated values of the relevant physical parameters.

In some example embodiments, that may be combined with any one or more of the above-described embodiments, the step of calculating feedback gains for the LQI controller is free from matrix calculation involving a numerical representation of matrix A of the dynamic physical system. This results in reduced computation load on the CPU for performing the calibration.

In some example embodiments, that may be combined with any one or more of the above-described embodiments, the method further comprises a setup phase of the LQI controller that is performed before said calibration of the feedback gains K, wherein the setup phase includes: determining the terms of the matrices A, B and C in form of ones, zeros, and equations having physical constants of the system as expression, while omitting the step of transforming the matrices A, B and C to a controllable canonical form; determining a feedback control system having an Integral Linear Quadratic (LQI) controller that outputs system input u that minimizes the criteria J where

$$J = {\int }_{0}^{∞} [ \begin{matrix}{x}^{T} & ε\end{matrix} ] Q [ \begin{matrix}{x}^{T} & ε\end{matrix} ] + {u}^{T} ru ,$$

wherein Q is matrix and r is a scalar, and wherein the LQI feedback controller includes said feedback gains; determining the characteristic equation of the control system; determining the transfer function of the control system, and subsequently determining the location of the poles of the transfer function; and deriving equations for the terms of each of the Q and P matrix using the Algebraic Riccati Equation:

$${PA}_{aug} + {A}_{aug}^{T} P - {PB}_{aug} {r}^{- 1} {B}_{aug}^{T} P + Q = 0 .$$

The setup phase is generally performed only once and may for example be performed during a design phase of the physical system.

In some example embodiments, that may be combined with any one or more of the above-described embodiments, the characteristic equation of the closed loop control system has the following form:

$$det ( sI - {A}_{aug} + {B}_{aug} {r}^{- 1} {B}_{aug}^{T} P ) = 0 .$$

In some example embodiments, that may be combined with any one or more of the above-described embodiments, the equations for the terms of the P matrix are also derived based on the denominator of the transfer function in combination with the coefficients and constant terms of the characteristic polynomial of the closed loop system. The transfer function may thus be used for finding the algebraic solution to the equations of the P matrix.

In some example embodiments, that may be combined with any one or more of the above-described embodiments, the method further comprises determining the location of the poles of the transfer function by Laplace-inverse-transforming the denominator of the transfer function and inputting the values of any point of a step response of the transfer function G(s), thereby enabling calculation of the natural frequency wₙ, which gives the location of the poles of the transfer function. The location of the poles is generally required for being able to calculate the equations of the terms of the P matrix.

In some example embodiments, that may be combined with any one or more of the above-described embodiments, the transfer function includes a damping ratio ζ, and wherein the damping ratio ζ is selected to be equal to about 1.0, or exactly 1.0. A critically damped system if often a good choice, because this may eliminate overshoot and thus a simplified control of controllable device.

In some example embodiments, that may be combined with any one or more of the above-described embodiments, the transfer function includes a natural frequency wₙ.

In some example embodiments, that may be combined with any one or more of the above-described embodiments, the Q matrix is a diagonal weight matrix having the following form:

$$Q = [ \begin{matrix}{q}_{1} & … & 0 \\ ⋮ & ⋱ & ⋮ \\ 0 & … & {q}_{n}\end{matrix} ] .$$

In some example embodiments, that may be combined with any one or more of the above-described embodiments, the step of omitting transformation of the matrices A, B and C to a controllable canonical form enables the terms of matrices A, B and C to retain their original expressions as functions of detectable system parameters, such that the equations for calculating the terms of the P matrix may be expressed in terms of as functions of detectable system parameters, thereby enabling computational-easy calculation of new feedback gains suitable for implementation in a low-computational system, such as in particular a vehicle system.

In some example embodiments, that may be combined with any one or more of the above-described embodiments, the physical electric or electro-mechanical device of the dynamic physical system is an actuator, a motor, a pump, a light or RF source, or an electro-dynamic device.

In some example embodiments, that may be combined with any one or more of the above-described embodiments, the dynamic physical system is a vehicle system, specifically a vehicle power train system, and more specifically a vehicle power train system having a first electric machine operatively connected to a first part of a dog clutch, wherein the electronic controller controls the rotational speed of the first part of the dog clutch for speed synchronising with a second part of the dog clutch, such that the first and second dog clutch parts can be shifted from disengaged state to engaged state in a smooth and noise-free manner. Implementing an LQI controller for the dog clutch that shifts driving mode between serial and parallel hybrid driving mode is beneficial, because a low steady state error is required for ensuring a smooth and noise less engagement, and because the engagement process is not time critical.

In some example embodiments, that may be combined with any one or more of the above-described embodiments, the predetermined equations for calculating numerical values of the individual terms of the P matrix include at least one parameter defining a functional requirement of the physical system. Thereby, the algebraic approach for determining the feedback gains of the LQI controller based upon the physical parameters of the vehicle and the functional requirements of the system, according to the present disclosure, not only guarantee stability but also control requirement fulfilment.

In some example embodiments, that may be combined with any one or more of the above-described embodiments, the vehicle power train system is implemented in a hybrid electric vehicle having a combustion engine drivingly connected to the first electric machine, and second electric machine drivingly connected to the second part of the dog clutch, and wherein shifting of the first and second dog clutch parts from disengaged state to mutually engaged state results in switching from serial to parallel operation of the hybrid electric vehicle. Implementing an LQI controller for the dog clutch that shifts driving mode between serial and parallel hybrid driving mode is beneficial, because a low steady state error is required for ensuring a smooth and noise less engagement, and because the engagement process is not time critical.

In some example embodiments, that may be combined with any one or more of the above-described embodiments, the physical parameters of the dynamic system are configured to be obtained by {\displaystyle \det(\lambda I-A)=0} manually by a user that is measuring, detecting or estimating the values of the physical parameters of the dynamic system, and/or by the electronic control unit that automatically conducts measurements, detects or estimates the values of the physical parameters of the dynamic system.

In some example embodiments, that may be combined with any one or more of the above-described embodiments, wherein the data memory further includes the terms of the matrices A, B and C in form of ones, zeros, and equations having physical constants of the system as expression, wherein the matrices A, B and C have not been transformed into a controllable canonical form, wherein the LQI controller is configured to output a control system input u that minimizes the criteria J where

$$J = {\int }_{0}^{∞} [ {x}^{T} ε ] Q [ {x}^{T} ε ] + {u}^{T} ru ,$$

and where Q is matrix and r is a scalar, wherein the equations for the terms of the Q matrix is stored in the data memory.

In some example embodiments, that may be combined with any one or more of the above-described embodiments, the matrices A, B and C stored in the data memory have not been transformed into a controllable canonical form, and the terms of matrices A, B and C are therefore retained in their original expressions as functions of detectable system parameters, such that the equations for calculating the terms of the P matrix may be expressed in terms of as functions of detectable system parameters, thereby enabling computational-easy calculation of new feedback gains suitable for implementation in a low-computational system, such as in particular a vehicle system.

In some example embodiments, that may be combined with any one or more of the above-described embodiments, the predetermined equations for calculating numerical values of the individual terms of a P matrix also include at least one parameter defining a functional requirement of the physical system, wherein said feedback gains of the LQI controller is configured to be calibrated by: obtaining values of various physical parameters of the dynamic system and at least one value of a parameter defining the functional requirement of the physical system; {\displaystyle \det(lambda I-A)=0} inserting the obtained values of the physical parameters and functional requirement into the predetermined equations for calculating numerical values of the individual terms of a P matrix; and subsequently calculating new feedback gains for the LQI controller based on the matrix equation

$$K = {r}^{- 1} {B}_{aug}^{T} P .$$

Thereby, the algebraic approach for determining the feedback gains of the LQI controller based upon the physical parameters of the vehicle and the functional requirements of the system, according to the present disclosure, not only guarantee stability but also control requirement fulfilment.

The present disclosure also relates to a hybrid electric vehicle having a vehicle power train system including: a dog clutch having first and second parts; a combustion engine drivingly connected to the first electric machine that is operatively connected to the first part of the dog clutch; a second electric machine drivingly connected to the second part of the dog clutch, and a dynamic physical system as described above.

In some example embodiments, that may be combined with any one or more of the above-described embodiments, a shift of the first and second dog clutch parts from disengaged state to mutually engaged state is configured to switch operation of the hybrid electric vehicle from serial to parallel operation.

Further features and advantages of the invention will become apparent when studying the appended claims and the following description. The skilled person in the art realizes that different features of the present disclosure may be combined to create embodiments other than those explicitly described hereinabove and below, without departing from the scope of the present disclosure.

### BRIEF DESCRIPTION OF DRAWINGS

The method and system according to the disclosure will be described in detail in the following, with reference to the attached drawings, in which

FIG. 1A shows schematically a side-view of a vehicle having a hybrid electric drivetrain,

FIG. 1B shows schematically a layout of an example embodiment of a hybrid electric drivetrain,

FIG. 2 shows speed and torque plot over time for a speed synchronization phase,

FIGS. 3A-3C show a schematic view of an example embodiment of a dog clutch including a dog clutch actuation mechanism,

FIGS. 4A-4D show four different phases of a dog teeth engagement,

FIG. 5 shows noise result of a lab test of clutch engagements,

FIGS. 6A-6B show the impact of drag torque on dog teeth motion path during engagement,

FIG. 7 shows schematically a 2DOF torsional system,

FIG. 8 shows a linear state feedback control system,

FIG. 9 shows a speed plot over time for a speed synchronization phase,

FIG. 10 shows a linear state feedback control system with LQI controller,

FIG. 11 shows a step response of a fourth order system,

FIG. 12 shows a step response of a critically damped fourth order system,

FIG. 13 shows rotational speed states during speed synchronization,

FIG. 14 shows controller performance fulfilling functional requirements,

FIG. 15 shows controller performance for different functional requirements,

FIG. 16 shows Vibration isolation for controllers with different functional requirements with thick dotted lines for tsynch=2 sec and thin dashed lines for tsynch=1 sec,

FIGS. 17A-17B shows schematically the main steps of two embodiments of the method according to the disclosure,

FIG. 18 shows schematically a general system according to the disclosure.

### DETAILED DESCRIPTION OF EXAMPLE EMBODIMENTS

Various aspects of the disclosure will hereinafter be described in conjunction with the appended drawings to illustrate and not to limit the disclosure, wherein like designations denote like elements, and variations of the described aspects are not restricted to the specifically shown embodiments, but are applicable on other variations of the disclosure.

The disclosure relates to a method for calibration of an LQI controller that is provided for implementing a feedback control strategy to minimize one or more operational parameters of a physical system, as well as a corresponding dynamic physical system including a LQI controller.

LQI controllers in general have the advantage of providing a robust state feedback design in combination with no steady state error due to the integrator part, thereby rendering LQI controllers highly useful, for example in in applications where a steady state error is not acceptable.

The LQI calibration process disclosed herein may thus be implemented in many different types of physical systems in a many different technical areas, such as for example, but not restricted to, vehicles, avionics, marine vessels, energy power generators, etc.

One specific implementation of a LQI controller is for controlling speed synchronization of a dog clutch prior to engagement for providing a smooth and noise-free cutch engagement process.

Calibration of the LQI controller enables minimization of mechanical noise during dog clutch engagement. Dog clutches are used in a large variety of technical implementations for enabling selective torque transfer between first and second dog clutch portions.

Dog clutch engagement process may for example occur during automatic gearshifts in a stepped transmission, such as for example an automatic single or dual clutch transmission, or an automated manual transmissions (AMT), or the like. Alternatively, or in addition, dog clutch engagement process may occur when shifting a conventional dog clutch from disengaged state to engaged state. A conventional dig clutch herein refers to a dog clutch having a first clutch portion rotationally fixed to a first shaft, a second clutch portion rotationally fixed to a second shaft that is separate but aligned with the first shaft. Dog clutch engagement may be accomplished by axially sliding an outer clutch engagement sleeve for selectively setting the first and second clutch portions in rotational connected state. Alternatively, dog clutch engagement may be accomplished by axially sliding for example the first clutch portion relative to the first shaft for selectively setting the first and second clutch portions in rotational connected state.

The use of a relatively simple and robust dog clutch for selective torque transfer between a power source and a power consumer provides a low cost overall design, and a calibration process of the LQI controller that controls the clutch engagement process may provide substantially interference-free low-noise engagement with little wear, thereby providing increased lifetime, reduced maintenance and improved user satisfaction.

The method for calibration of an LQI controller, as well as a corresponding dynamic physical system including a LQI controller, will be described more in detail below in an example implementation of the dog clutch in a powertrain of a hybrid electric vehicle. The method and system according to the present disclosure is however not limited to this specific example implementation, but may alternatively be implemented in a large variety of technical systems.

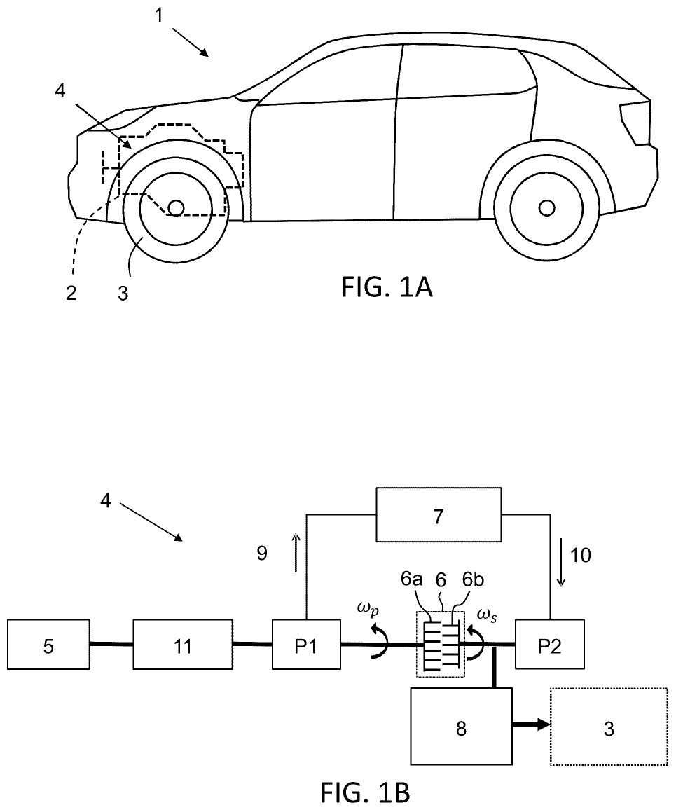

For setting the dog clutch and vehicle powertrain according to this example embodiment in a context, FIG. 1A shows schematically a car 1 having a powertrain 4 including a propulsion power source 2, such as internal combustion engine and an electric machine, drivingly connected to driving wheels 3 of the car 1 via a transmission.

The example powertrain 4 of the hybrid electric vehicle 1 is described more in detail with reference to FIG. 1B. The powertrain 4 of the hybrid electric vehicle comprises an internal combustion engine (ICE) 5 drivingly connected to a first electric machine P1 that is arranged for charging a high-voltage battery 7, as indicated in FIG. 1B by a charging arrow 9. The powertrain 4 further comprises a second electric machine P2 that is powered by the battery 7 and drivingly connected to the vehicle wheels 3 via a transmission 8 for converting the rotational speed of the second electrical motor P2 to suitable vehicle wheel speed. Powering of the second electric machine P2 by means of electrical power from the battery 7 is indicated in FIG. 1B by a discharging arrow 10.

For efficiency during driving, at high vehicle speeds the ICE 5 may become drivingly connected to wheels 3 via a dog clutch 6, hence shifting the vehicle from series to parallel hybrid mode.

As schematically illustrated in FIG. 1B, the internal combustion engine 5 may be connected to the first electric machine P1 via a dual mass flywheel (DMF) 11. The first electric machine P1 is connected to the first part 6a of the dog clutch 6, and the secondary part 6b of the dog clutch 6 is connected to the second electric machine P2. Power is supplied to the second electric machine P2 by the battery 7. Power levels of the second electric machine P2 may for example be in the range of 50-300 kW, specifically in the range of 100-150 kW, depending on the vehicle size. The ICE may have a similar power range.

It is shown by experimental results that if the speed difference between the two sides, i.e. first and second parts 6a, 6b, of the dog clutch 6 is below a certain level the engagement will be without clonk noise. In this example embodiment of the disclosure, the designed state feedback Linear Quadratic Integral (LQI) control provides the synchronization torque request to the first electric machine P1, hence matching the speed of the first part 6a of dog clutch 6 with the second part 6b of the dog clutch 6 under the disturbance from combustion torque of the combustion engine 5.

Normally LQI controllers are tuned by trial-and-error methods or by extensive computational-heavy matrix calculations, but this disclosure presents an algebraic approach where the feedback gains of the LQI controller are calculated based solely upon the physical parameters of the system, the required time for speed synchronization and acceptable values of speed difference from experimental results. This approach minimizes the need for manual tuning and can deliver the controller gains for any size and version of the transmission by just modifying the parameter values and functional requirements.

While driving, the vehicle 1 can be operating in different driving modes. For example, the powertrain of the hybrid electric vehicle according to the example illustrated in FIG. 1B, the powertrain can be operated in following driving modes:
1. Pure Electric
2. Series Hybrid
3. Parallel Hybrid

In pure electric driving mode the ICE 5 is shut off, the dog clutch 6 is set in open state, and the second electric machine P2 is providing the driving torque to the wheels 3. The discharge power flow from the battery 7 to the second electric machine P2 is shown by arrow 10.

When state of charge of the battery 7 is low the powertrain 5 of the vehicle 1 may be shifted to series hybrid driving mode. Then the first electric machine P1 motor can take power from the battery 7 for temporarily operating as an engine starter motor. Once the ICE 5 is running, the ICE 5 may for example be used as a range extender and the battery 7 is charged by electrical energy supplied and generated by the first electric machine P1.

Furthermore, when the vehicle speed is larger than a particular value v₁, for efficiency the powertrain 4 of the vehicle 1 may be set in a parallel hybrid driving mode. In parallel driving mode the dog clutch 6 is closed, hence drivingly connecting the ICE 5 with the vehicle wheels 3. Switching the driving mode from pure electric or series hybrid driving mode to parallel driving mode comprises three distinct phases.
1. Speed synchronization
2. Dog clutch engagement
3. Torque Ramp up

In the first phase “Speed synchronization” the rotational speed ωₚ of primary side 6a of dog clutch 6, in FIG. 1B is controlled, by means of the first electric machine P1, to match the rotational speed ωₛ of secondary side 6b of dog clutch 6. The speed difference the primary and secondary sides 6a, 6b of the dog clutch 6, i.e. speed different between ωₚ and ωₛ, at the end of phase 1 determines the level of noise generated in phase 2: “Dog Clutch Engagement”. Experimental results presented in this disclosure show the limits on speed difference at the end of phase 1 which will lead to noise-less dog clutch engagement.

To minimize the speed difference at dog clutch engagement, a torque request on the first electric machine P1 is calculated by the feedback controller designed in the later sections of this disclosure. From FIG. 1B, it can be seen that primary side 6a of dog clutch 6 consists of two inertias i.e. ICE and the first electric machine P1 connected by an elastic coupling in the dual mass flywheel 11. This disclosure provides an algebraic approach for calculating the weighting matrices of the LQI controller based the algebraic Riccati equation, while clearly defining the weighting matrices based on physical parameters of the two inertia system, the required speed synchronization time and limits on speed difference at the end of speed synchronization. This new approach minimizes the need for manual tuning of the controller, while fulfilling the stability and noise rejection requirements.

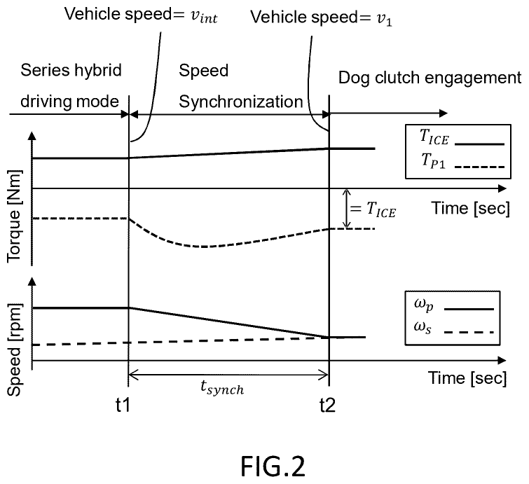

FIG. 2 shows the first two phases of the mode switch during vehicle acceleration. Before time point t1, vehicle speed is less than a particular value vᵢₙᵢₜ, the first electric machine P1 is running in generator mode and is applying a constant braking torque on the engine. At time point t1, vehicle speed is equal to vᵢₙᵢₜ and the speed synchronization phase starts. During the speed synchronization phase, the braking torque of the first electric machine P1 is temporarily increased until the desired engine speed is reached at time point t2, which enables a smooth and noise-free engagement of the primary and secondary sides of the dog clutch 6. This braking torque during speed synchronization is calculated by the feedback controller explained in the later sections of this disclosure.

Speed synchronization between primary and secondary side can alternatively be achieved by simply cutting the fuel to the ICE 5 and letting the speed of the primary side 6a of the dog clutch 6 decrease under friction, but is more controllable to use braking torque from the first electric machine P1.

Speed synchronization takes time t_{synch}. It is assumed that the speed ωₛ of the secondary side 6b the dog clutch 6 at time point t2 is accurately predicted by the hybrid electric powertrain, and vehicle speed is equal to v₁ at time point t2. Based on vehicle acceleration aᵥₑₕ, duration of the synchronisation time t_{synch}, vehicle speed v₁ at time point t2, and vehicle speed vᵢₙᵢₜ at time point t1 can be calculated by

$${v}_{init} = {v}_{1} - {a}_{veh} {t}_{synch} \qquad ( 1 )$$

In this disclosure

$${t}_{synch} = 2 sec \qquad ( 2 )$$

Since speed synchronization is not time critical for this particular transmission, two seconds is a reasonable choice. Once the speed synchronization phase is finished, the second phase “Dog clutch engagement” is started. If the speed is matched perfectly there will be minimum noise and wear in the transmission.

The speed difference ω_{diff} is defined as

$${ω}_{diff} = {ω}_{p} - {ω}_{s} \qquad ( 3 )$$

To minimize noise and wear ω_{diff} must be within certain limits before the dog clutch is engaged, as discussed in later sections of this disclosure.

After dog clutch engagement the torque at the wheels 3 will be the sum of the torque from ICE 5, and first and second electric machines P1, P2. To keep a smooth acceleration of the vehicle during the driving mode shift, it may be desirable to manage the torque from all sources such that the toque demand for constant acceleration is fulfilled during the whole driving mode shift.

From the above section it can be concluded that the first phase in the driving mode switch i.e. speed synchronization is not time critical. Depending on the power available for the first electric machine P1 for speed synchronization, synchronization time t_{synch} will change, hence changing the speed vᵢₙᵢₜ when the speed synchronization should start. As opposed to transmissions in conventional powertrains, where driving mode switch and speed synchronization is a time critical problem for fulfilling the torque request, the controller design in this disclosure will be focused on speed synchronization and dog clutch engagement without noise and wear.

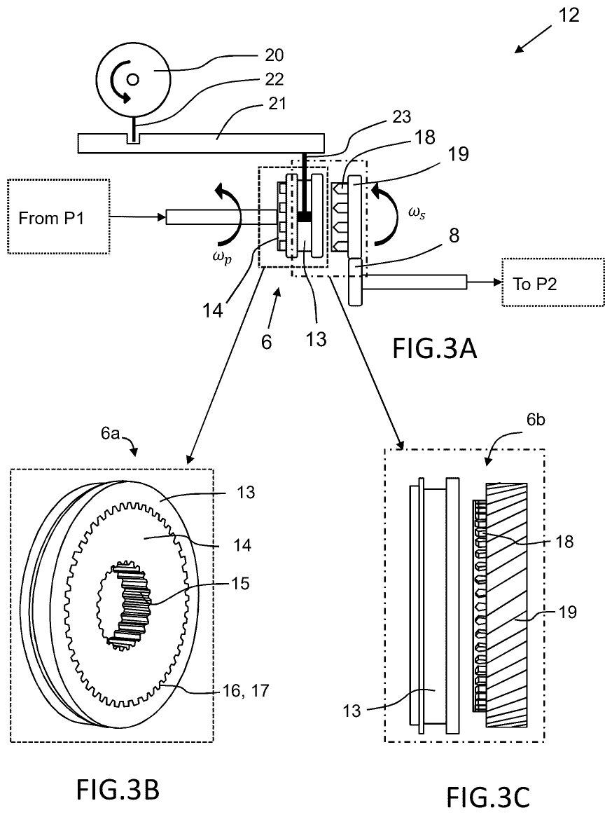

FIG. 3A shows a schematic illustration of an example embodiment of an actuation mechanism 12 of the dog clutch 6. In this example embodiment, the primary side 6a of the dog clutch comprises a sleeve 13 and hub 14, and they are shown in an enlarged view in FIG. 3B. The hub 14 has outer axially extending dog teeth 16 that are connected to inner axially extending dog teeth 17 of the sleeve 13 for enabling axial motion of the sleeve 13 relative to the hub 14, which is rotationally fastened to the input shaft of the first electric machine P1 via a splines connection 15.

The disengaged side of the dog clutch 6 is shown in an enlarged view in FIG. 3C, and the secondary side 6b of the dog clutch 6 comprises outer dog teeth 18 configured for engaging the inner dog teeth 17 of the sleeve 13, when the sleeve 13 is axially displaced towards the secondary side of the dog clutch 6, during engagement of the dog clutch 6. The second electric machine P2 is connected to the secondary side of the dog clutch 6 via the transmission 8, as shown in FIGS. 3A and 3C.

With reference to FIG. 3A, axial displacement of the sleeve 13 towards and away from secondary side of the dog clutch 6, for setting the dog clutch 6 in engaged or disengaged state, is for example performed by means of an electric shifter motor that drives a linearly moveable shifter rail 21. The rotational to linear motion conversion between shifter motor to shifter rail may for example be accomplished by a shift finger 22. Moreover, axial displacement of the sleeve 13 may be accomplished by means of a shift fork 23 that is fastened to the shifter rail 21 and engages the sleeve 13.

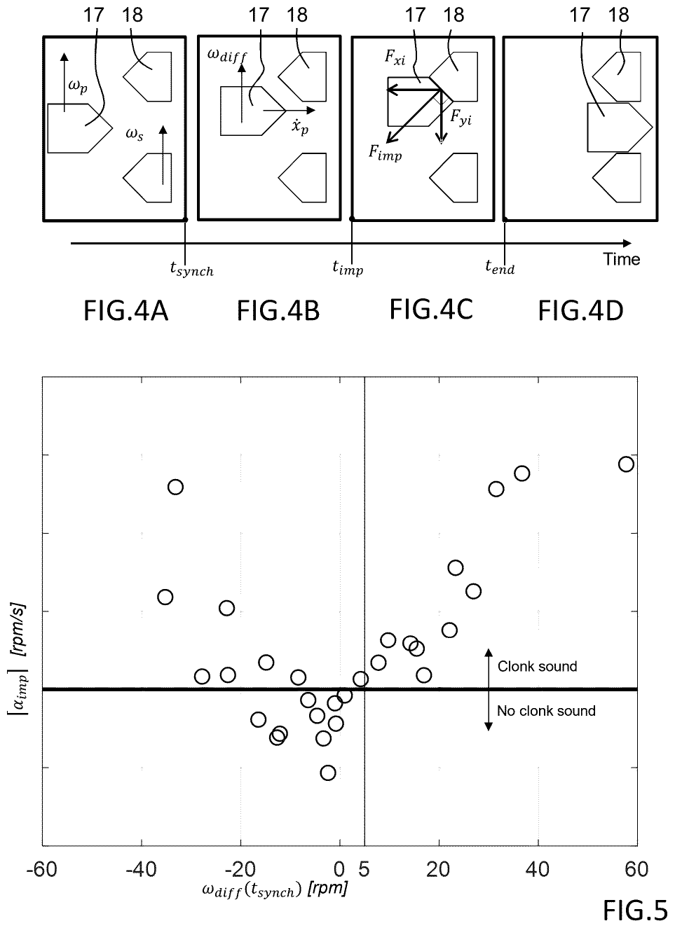

FIG. 4A-4D show the forces and velocities involved on primary and secondary dog teeth, during the engagement process, wherein FIG. 4A shows a disengaged dog clutch, FIG. 4B shows the dog clutch while moving towards engagement, FIG. 4C shows the dog clutch upon dog teeth impact, and FIG. 4D shows the dog clutch in engaged state.

FIG. 4A shows the relative position of the dog teeth of a disengaged dog clutch at the end of speed synchronization phase. Primary dog teeth, i.e. dog teeth 17 of sleeve 13, are moving with a rotational speed @p and secondary side dog teeth, i.e. dog teeth 18 of secondary side 6b, are moving with rotational speed @s.

When the shifter motor 20 is rotated in the shift direction shown by rotational arrow in FIG. 3A, the shift fork 23 will move the sleeve 13 with an axial velocity \dot{x}ₚ as shown in FIG. 4B. The rotational speed difference can be simplified by assuming that the secondary teeth 18 are at rest and the primary teeth 17 are rotating with the speed difference ω_{diff} defined by equation 3.

Since the primary side speed ωₚ is being controlled by the feedback controller and ωₛ is proportional to the vehicle speed, it can be assumed that, for the short time instance of the engaging phase, ω_{diff} will be constant.

When the primary dog teeth 17 have moved a certain distance at time tᵢₘₚ, they will come into contact with the secondary dog teeth 18 as shown in FIG. 4C. Depending on the axial speed \dot{x}ₚ and the rotational speed difference ω_{diff} at tᵢₘₚ, an impact force Fᵢₘₚ, normal to the impact surface, will be generated on both teeth. The impact force will be directly proportional to ω_{diff}(tᵢₘₚ) and \dot{x}ₚ and is responsible for noise and wear.

The axial component Fₓᵢ of the impact force Fᵢₘₚ shown in FIG. 4C will resist the engagement and is overcome by the shifter motor 21 shown in FIG. 3A. Once the primary dog teeth 17 have moved a certain distance and are engaged with the secondary dog teeth 18, at time t_{end}, the third phase of the driving mode shift can be started, namely the “Torque Ramp up” phase.

At time tᵢₘₚ, when the dog teeth 17, 18 collide, the tangential component of the impact force F_{yi} will affect the rotational velocities ωₚ and ωₛ of the dog teeth. The effect can be measured by angular acceleration αᵢₘₚ of the teeth. αᵢₘₚ at impact can be defined by:

$${α}_{imp} = constant {F}_{yi} \qquad ( 4 )$$

The maximum value of the acceleration αᵢₘₚ will be at the time instance tᵢₘₚ and is denoted by [αᵢₘₚ].

During normal operation of the vehicle, ω_{diff}(t_{synch}) must be very close to zero before the dog clutch engagement. Lab tests were done by engaging the dog clutch at different values of ω_{diff}(t_{synch}) and measuring the maximum instantaneous angular acceleration and the noise from the dog clutch. The results are shown in FIG. 5.

It can be seen from FIG. 5, that if αᵢₘₚ is higher than a particular value clonk sound is heard during engagement. As shown in equation 4 a higher αᵢₘₚ means a higher impact force Fᵢₘₚ. Higher impact force Fᵢₘₚ is in turn a result of a higher ω_{diff}. From FIG. 5, it can be seen that if ω_{diff}(t_{synch}) is between −20 and 5 rpm there will most probably be no clonk sound.

During the lab tests shown in FIG. 5, the primary side speed ωₚ is not controlled, so from time instance t_{synch} to t_{end} the rotational speed difference ω_{diff} is not constant due to drag torque in the transmission.

Ideally, the pattern of points in FIG. 5, should be centred around zero ω_{diff}, as αᵢₘₚ is a function of absolute value of ω_{diff}.

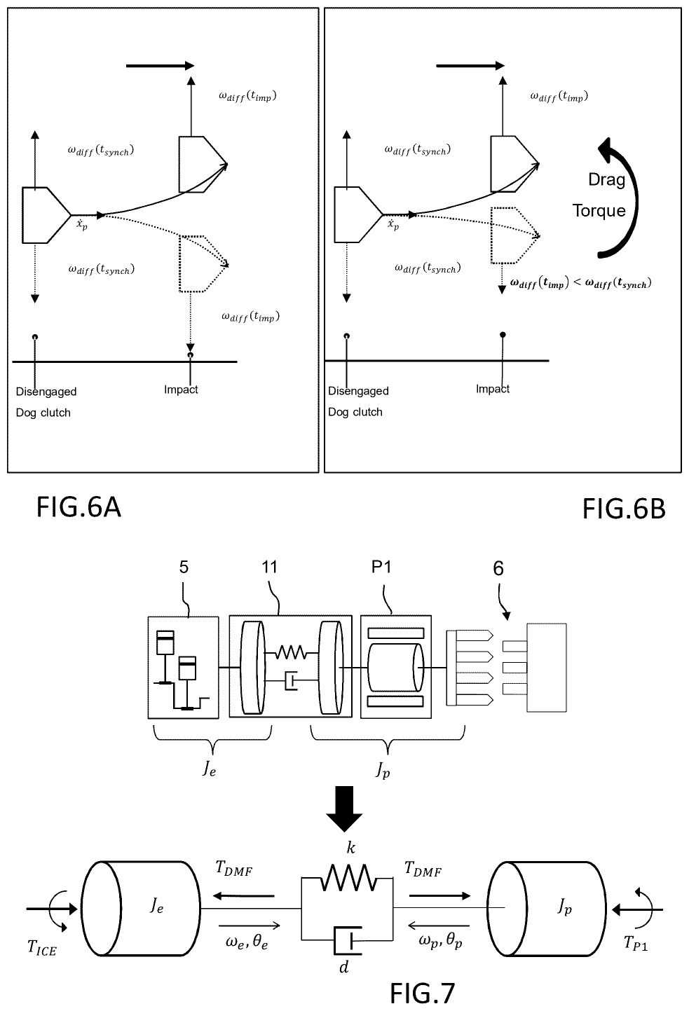

FIGS. 6A and 6B shows the axial movement of the primary dog without and with drag torque, respectively. As shown in FIG. 6A, if there is no drag torque in the transmission, then ω_{diff}(t_{synch}) will be equal to ω_{diff}(tᵢₘₚ), so the impact force would be the same irrespective of the direction of ω_{diff}. FIG. 6B on the other hand shows the impact of drag torque, wherein drag torque on either primary or secondary side can be represented by the directional drag torque.

The effect of directional drag torque will be different depending on the direction of ω_{diff}. For the drag torque shown in FIG. 6B, it can be seen that ω_{diff}(tᵢₘₚ) is less than ω_{diff}(t_{synch}), if ω_{diff} is in downwards direction resulting in lower Fᵢₘₚ and αᵢₘₚ than if ω_{diff} is in upwards direction. Consequently the noise produced by the impact will be lower if ω_{diff} is in downwards direction.

For this disclosure based on FIG. 5 and FIG. 6A-B, it can be safely assumed that

$$\vert {ω}_{diff} ( {t}_{synch} ) \vert < 5 rpm {⟹}_{results} No Clonk \qquad ( 5 )$$

To control the primary speed ωₚ to right value before the dog clutch 6 can be engaged, toque control of the first electric machine P1 is used. However, due to the dual mass flywheel 11 and the time variations of the engine torque, this is not a trivial control task. To ensure a fast, accurate and robust control of the primary speed, a controller is designed in the following section.

The components on the primary side of the dog clutch can be represented by a 2 Degree-Of-Freedom (DOF) torsional system as schematically shown in FIG. 7.

The torque from the ICE 5 acts on one side of the dual mass flywheel 11, and the torque of the first electric machine P1 on the other side of the dual mass flywheel 11. In between are several inertias, which can be lumped together into two inertias connected via a torsional spring and damper. The two inertias are

$$\begin{matrix}{J}_{p} = {J}_{Hub \& Sleeve} + {J}_{P 1 rotor} + {J}_{DM Fsecondary} \\ {J}_{e} = {J}_{crankshaft} + {J}_{Flywheel} + {J}_{DMFprimary}\end{matrix} \qquad ( 6 )$$

The torque T_{DMF} applied by the torsional spring and damper of the DMF on both the inertias Jₚ and Jₑ is

$${T}_{DMF} = d ( {ω}_{p} - {ω}_{e} ) + k ( {θ}_{p} - {θ}_{e} ) \qquad ( 7 )$$

Defining Δθ, such that

$$Δ θ = {θ}_{p} - {θ}_{e} \qquad ( 8 )$$

Applying Newton's 2nd law on inertia Jₚ and Jₑ a set of two differential equations describing the speed dynamics of the system are obtained:

$$\begin{matrix}{J}_{p} {\dot{ω}}_{p} = - d {ω}_{p} - k Δθ + d {ω}_{e} + {T}_{P 1} \\ {J}_{e} {\dot{ω}}_{e} = d {ω}_{p} + k Δθ - d {ω}_{e} - {T}_{ICE}\end{matrix} \qquad ( 9 )$$

Differentiating equation 8 on both sides gives

$$Δ \dot{θ} = {ω}_{p} - {ω}_{e} \qquad ( 10 )$$

Combing the differential equations in equations 9 and 10 the linear time invariant state space model of the mechanical system in FIG. 7 can be obtained by setting the disturbance T_{ICE}=0, such that

$$\begin{matrix}\dot{x} = Ax + Bu \\ y = Cx\end{matrix} \qquad ( 11 )$$

where state vector x is

$$\begin{matrix}x = {[ {ω}_{p} Δθ {ω}_{e} ]}^{T} \\ and\end{matrix} \qquad ( 12 )$$

$$A = [ \begin{matrix}- d / {J}_{p} & - k / {J}_{p} & d / {J}_{p} \\ 1 & 0 & - 1 \\ d / {J}_{e} & k / {J}_{e} & - d / {J}_{e}\end{matrix} ] = [ \begin{matrix}- {a}_{1} & - {a}_{3} & {a}_{1} \\ 1 & 0 & - 1 \\ {a}_{2} & {a}_{4} & - {a}_{2}\end{matrix} ] \qquad ( 13 )$$

$$B = {[ \begin{matrix}1 / {J}_{p} & 0 & 0\end{matrix} ]}^{T} = {[ \begin{matrix}b & 0 & 0\end{matrix} ]}^{T} \qquad ( 14 )$$

The constants a₁ to a₄ in equation 13 and constant b in equation 14 are positive numbers and depend on the physical constants of the system.

Vector C in equation 11 will be

$$C = [ 100 ] \qquad ( 15 )$$

since only the first state ωₚ i.e. the primary side dog teeth speed is to be controlled during speed synchronization.

For synchronizing the speed of the primary side of the dog clutch the input u to the system will be the torque request from the first electric machine P1 so

$$u = {T}_{P 1} \qquad ( 16 )$$

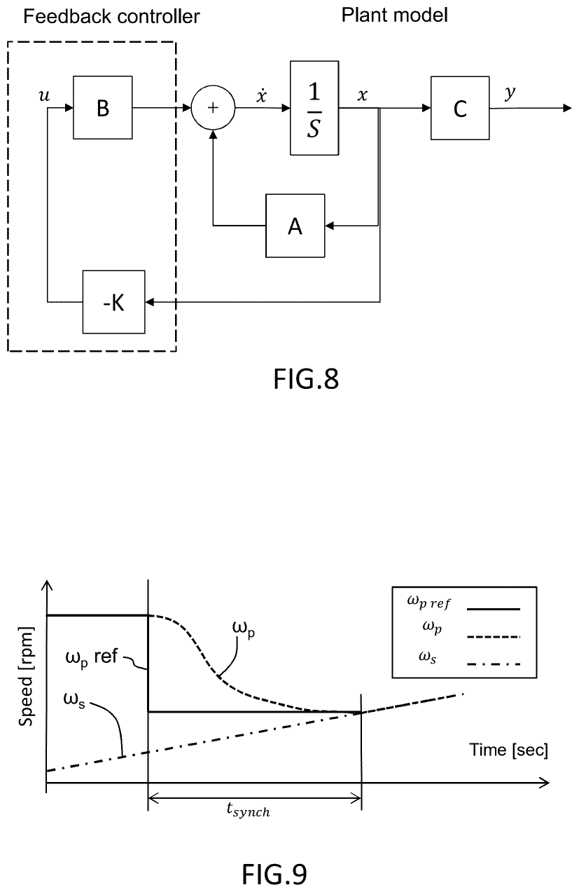

A linear state feedback controller is chosen because it can be easily implemented in the existing transmission control software. In FIG. 8 the plant model is shown on the right side with state feedback controller on the left side indicated by a dashed line, where K is the linear state feedback gain.

From FIG. 8, the torque request on the first electric machine P1 in equation 16 can be rewritten as

$$u = - Kx \qquad ( 17 )$$

In order to minimize the speed difference ω_{diff} in equation 3 under the disturbance from T_{ICE}, the first state of the system in equation 12 ωₚ, needs to reach the target speed shown by ω_{pref} as shown in FIG. 9.

From FIG. 9, it can be seen that at time t_{synch}, ω_{pref} is equal to ωₛ, so if ωₚ reaches ω_{pref}, after time t_{synch}, dog clutch can be engaged without noise. To analyze the control of the speed an error ε can be introduced

$$ε = {ω}_{pref} - {ω}_{p} \qquad ( 18 )$$

Adding the integral of the error ε in the system (11) as an additional state, an integral action of the feedback control is obtained which will eliminate the steady state error. With this new state the augmented state space model will be

$$\begin{matrix}[ \begin{matrix}\dot{x} \\ ε\end{matrix} ] = {A}_{aug} x + {B}_{aug} u + [ \begin{matrix}0 \\ 1\end{matrix} ] {ω}_{pref} \\ y = {C}_{aug} [ \begin{matrix}x \\ ε\end{matrix} ]\end{matrix} \qquad ( 19 )$$

$$where$$

$${A}_{aug} = [ \begin{matrix}A & 0 \\ - C & 0\end{matrix} ] , {B}_{aug} = {[ B 0 ]}^{T} , {C}_{aug} = [ C 0 ] \qquad ( 20 )$$

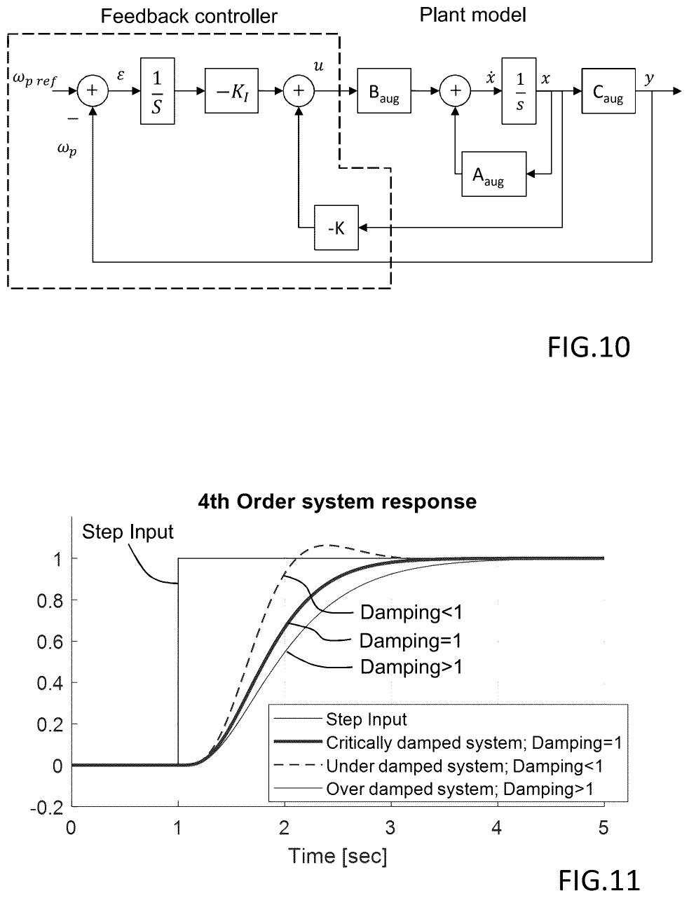

The feedback control system in FIG. 8 updated with the integral state and reference ω_{pref} is shown in FIG. 10. FIG. 10 this describes a reference tracking integral control system.

From FIG. 10, the torque request u on the first electric machine P1 can be rewritten as

$$u = - Kx - {K}_{I} {\int }_{0}^{t} ε \cdot dt \qquad ( 21 )$$

The state feedback can be selected in many ways, but generally it is desirable to find a controller gain that is optimal regarding some criteria. One way to find an optimal feedback control law for equation 21 can be obtained by solving infinite time linear quadratic problem, which results in a LQI control. This type of controller outputs the control input u that minimizes the criteria J where

$$J = {\int }_{0}^{∞} [ {x}^{T} ε ] Q [ {x}^{T} ε ] + {u}^{T} ru \qquad ( 22 )$$

By using this method the resulting controller will be robust and inherently stable.

Matrix Q and scalar r in equation 22 can be defined as

$$Q = [ \begin{matrix}{q}_{1} & 0 & 0 & 0 \\ 0 & {q}_{2} & 0 & 0 \\ 0 & 0 & {q}_{3} & 0 \\ 0 & 0 & 0 & {q}_{4}\end{matrix} ] , wherein r > 0 \qquad ( 23 )$$

The elements of matrix Q and r, define the weights on states and control input in the criteria to be minimized (22). When determining the LQI controller gain, the absolute values of Q and r are not important. Rather, it is their relative values which determines the feedback gain of the controller. A relative high value on q₄ for instance means that keeping the integral error a small, is more important than keeping the other states or the control effort small. A very high value on r means that it is more important to keep the control effort u small, than to keep the state errors small.

The feedback gains K and K_{I} in equation 21 can, for an LQI controller, be calculated by

$$[ K {K}_{I} ] = {r}^{- 1} {B}_{aug}^{T} P \qquad ( 24 )$$

where P is the solution to the Algebraic Riccati equation i.e.

$${PA}_{aug} + {A}_{aug}^{T} P - {PB}_{aug} {r}^{- 1} {B}_{aug}^{T} P + Q = 0 \qquad ( 25 )$$

and is a symmetric matrix of the form

$$P = [ \begin{matrix}{p}_{11} & {p}_{12} & {p}_{13} & {p}_{14} \\ {p}_{12} & {p}_{22} & {p}_{23} & {p}_{24} \\ {p}_{13} & {p}_{23} & {p}_{33} & {p}_{34} \\ {p}_{14} & {p}_{24} & {p}_{34} & {p}_{44}\end{matrix} ] \qquad ( 26 )$$

The values of Q and r in equation 22 may for example be found experimentally, or being calculated based on characteristic equations of the closed loop system. But the characteristic equation has up to now always been based on the controllable canonical form of the system instead of the augmented system shown in equation 19.

It is desirable to be able to calculate the new feedback gains directly based on physical system parameters, because this enables a quick and simply calibration of the LQI controller, without need for extensive processing power. To keep the values of feedback gains in equation 24 dependent on the physical parameters of the system, the A, B and C matrices are not transformed to the controllable canonical form, because this would require inserting values of the physical parameters of the system at an early stage.

The core idea of the method for controller calibration in the following sections of this disclosure is to
Minimize the need for manual tuning
Be based on physical properties of the system and functional requirements so it can be used on any size and version of the transmission without needing to change anything other than parameter values
Guaranteed stability
Low steady state error
Noise rejection

The characteristic equation of the closed loop system in FIG. 10 can be written as

$$det ( sI - {A}_{aug} + {B}_{aug} K ) = 0 \qquad ( 27 )$$

Substituting K from equation 24 in equation 27

$$det ( sI - {A}_{aug} + {B}_{aug} {r}^{- 1} {B}_{aug}^{T} P ) = 0 \qquad ( 28 )$$

Roots of equation 28 define the poles of the closed loop system and hence define time response of the system. The system in equation 19 is a fourth order system, so four poles need to be decided. Once the poles of the system are decided, the solution P to algebraic Riccati equation can be calculated and then feedback gains in equation 24 will be calculated.

The transfer function of a 4th order system is

$$G ( s ) = \frac{{w}_{n}^{2}}{{s}^{4} + 4 ξ {w}_{n} {s}^{3} + {w}_{n}^{2} ( 2 + 4 {ξ}^{2} ) {s}^{2} + 4 ξ {w}_{n}^{3} s + {w}_{n}^{4}} \qquad ( 29 )$$

where wₙ is the natural frequency and ζ is the damping ratio.

FIG. 11 shows the response of a fourth order system with fixed natural frequency wₙ and variable damping ratios ζ.

From FIG. 11, it can be seen that the critically damped response reaches the steady state value in the least time. The under damped response is faster to reach the desired speed but does not stay there and continues and produces an overshoot. Since in this disclosure the control problem deals with speed synchronization, an overshoot will create NVH issues so, a critically damped system is chosen.

With ξ=1, and input(s) being a unit step the transfer function in equation 29 becomes

$$output ( s ) = \frac{1}{s} \frac{{w}_{n}^{2}}{{s}^{4} + 4 {w}_{n} {s}^{3} + 6 {w}_{n}^{2} {s}^{2} + 4 {w}_{n}^{3} s + {w}_{n}^{4}} \qquad ( 30 )$$

Using partial fractions equation 30 becomes

$$output ( s ) = \frac{1}{s} - \frac{1}{s + {w}_{n}} - \frac{{w}_{n}}{{( s + {w}_{n} )}^{2}} - \frac{{w}_{n}^{2}}{{( s + {w}_{n} )}^{3}} - \frac{{w}_{n}^{3}}{{( s + {w}_{n} )}^{4}} \qquad ( 31 )$$

Taking Laplace inverse on both sides of equation 31

$$output ( t ) = 1 - {e}^{- {w}_{n} t} ( 1 + {w}_{n} t + \frac{{w}_{n}^{2} {t}^{2}}{2} + \frac{{w}_{n}^{3} {t}^{3}}{3} ) \qquad ( 32 )$$

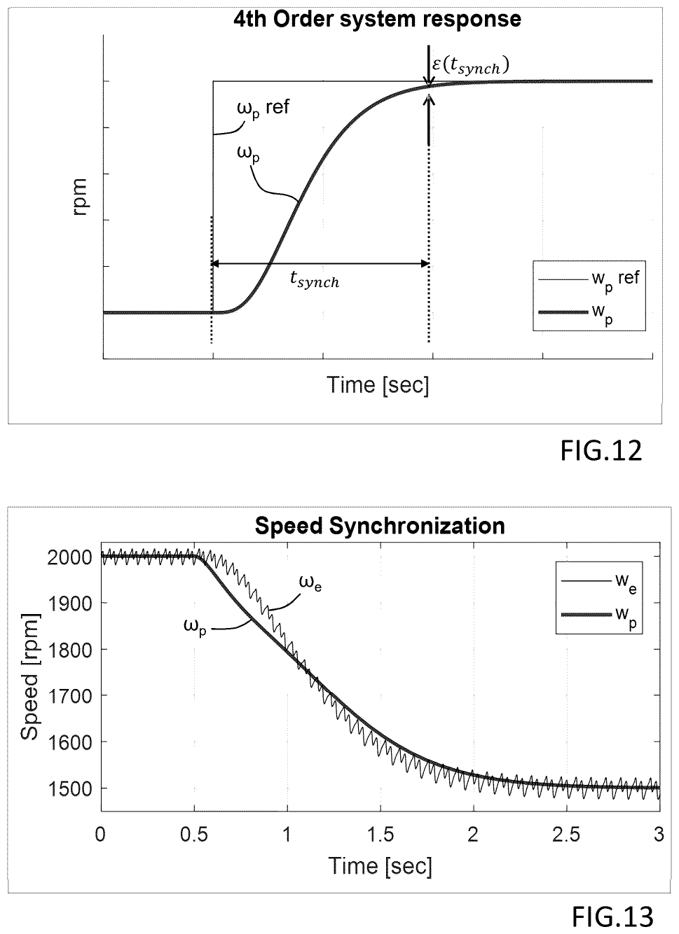

Equation 32 can be solved by using FIG. 12, which shows the step response of a critically damped fourth order system.

In FIG. 12, if step input is ω_{pref} from FIG. 9, the output will be ωₚ. The error ε in equation 18 can be used with equation 5 to define error ε(t_{synch}). If ε(t_{synch}) is within the limits defined in equation 5, the dog clutch can be engaged without noise after time t_{synch}.

Equation 32, represents the evolution of output or ωₚ with time. The requirement on ωₚ is such that after time t_{synch} it should reach ωₛ(t_{synch}) within error bounds defined by equation 5. So equation 32 can be rewritten as

$$\frac{limits of {ω}_{diff}}{{ω}_{s} ( {t}_{synch} )} = {e}^{- {w}_{n} {t}_{synch}} ( 1 + {w}_{n} {t}_{synch} + \frac{{w}_{n}^{2} {t}_{synch}^{2}}{2} + \frac{{w}_{n}^{3} {t}_{synch}^{3}}{3} ) \qquad ( 33 )$$

Since equation 33 has one unknown wₙ it can be solved, and the solution will be of the form

$${w}_{n} = constant / {t}_{synch} \qquad ( 34 )$$

Equation 34 represents the location of four poles of the transfer function in equation 29, wherein all four poles are located in the same location.

In this step value of wₙ from equation 34 will be used in denominator polynomial of transfer function in 29 to determine the elements in the P matrix.

By comparing the coefficients for s³, s², s and the constant term in equation 28 with denominator polynomial of equation 29, the following equation set is obtained, wherein p₁₁, p₁₂, p₁₃ and p₁₄ are unknowns that must be calculated:

$${a}_{1} + {a}_{2} + {p}_{11} * \frac{{b}^{2}}{r} = 4 ξ {w}_{n} \frac{{b}^{2}}{r} * {p}_{12} - \frac{{b}^{2}}{r} * {p}_{14} + {a}_{2} * \frac{{b}^{2}}{r} * {p}_{11} + {a}_{2} * \frac{{b}^{2}}{r} * {p}_{13} + {a}_{3} + {a}_{4} = {w}_{n}^{2} ( 2 + 4 {ξ}^{2} ) {a}_{4} * \frac{{b}^{2}}{r} * {p}_{11} - {a}_{2} * \frac{{b}^{2}}{r} * {p}_{14} + {a}_{4} * \frac{{b}^{2}}{r} * {p}_{13} = 4 ξ {w}_{n}^{3} - {a}_{4} * \frac{{b}^{2}}{r} * {p}_{14} = {w}_{n}^{4} \qquad ( 35 )$$

The constants a₁ to a₄ in equation 13 and constant b in equation 14 are positive numbers and depend on the physical constants of the system.

Since equation set 35 has four unknowns p₁₁, p₁₂, p₁₃ and p₁₄ and four equations, a unique solution of each of said unknowns can be calculated by setting ξ=1 and setting r an arbitrary positive number, such as for example 1.

Specifically, p11 is directly calculable based on the first line of equation 35, and p14 is directly calculable based on the last line of equation 35. Thereafter, p13 is directly calculable based on the third line of equation 35, and finally p12 is directly calculable based on the second line of equation 35.

After solving equation set 35, there will be six remaining unknown elements left in the P matrix in equation 26, also the four elements of the Q matrix in equation 23 need to be calculated. This requires 10 equations that can be obtained from matrix equation 25, wherein the terms p₂₂, p₂₃, p₂₄, p₃₃, p₃₄ and p₄₄ of the P matrix and q₁, q₂, q₃ and q₄ of the Q matrix are the unknowns that must be calculated:

$$2 {p}_{12} - 2 {p}_{14} + {q}_{1} - 2 {a}_{1} {p}_{11} + 2 {a}_{2} {p}_{13} - \frac{{b}^{2} {p}_{11}^{2}}{r} = 0 \qquad ( 36 )$$

$${p}_{22} - {p}_{24} - {a}_{1} {p}_{12} - {a}_{3} {p}_{11} + {a}_{4} {p}_{13} + {a}_{2} {p}_{23} - \frac{{b}^{2} {p}_{11} {p}_{12}}{r} = 0$$

$${p}_{23} - {p}_{12} - {p}_{34} + {a}_{1} {p}_{11} - {a}_{1} {p}_{13} - {a}_{2} {p}_{13} + {a}_{2} {p}_{33} - \frac{{b}^{2} {p}_{11} * {p}_{13}}{r} = 0$$

$${p}_{24} - {p}_{44} - {a}_{1} {p}_{14} + {a}_{2} {p}_{34} - \frac{{b}^{2} {p}_{11} {p}_{14}}{r} = 0$$

$${q}_{2} - 2 {a}_{3} {p}_{12} + 2 {a}_{4} {p}_{23} - \frac{{b}^{2} {p}_{12}^{2}}{r} = 0$$

$${a}_{1} {p}_{12} - {p}_{22} - {a}_{3} {p}_{13} - {a}_{2} {p}_{23} + {a}_{4} {p}_{33} - \frac{{b}^{2} {p}_{12} {p}_{13}}{r} = 0$$

$${a}_{4} {p}_{34} - {a}_{3} {p}_{14} - \frac{{b}^{2} {p}_{12} {p}_{14}}{r} = 0$$

$${q}_{3} - 2 {p}_{23} + 2 {a}_{1} {p}_{13} - 2 {a}_{1} {p}_{33} - \frac{{b}^{2} {p}_{13}^{2}}{r} = 0$$

$${a}_{1} {p}_{14} - {p}_{24} - {a}_{2} {p}_{34} - \frac{{b}^{2} {p}_{13} {p}_{14}}{r} = 0$$

$${q}_{4} - \frac{{b}^{2} {p}_{14}^{2}}{r} = 0$$

Similar to above, this equation set 36 is solved by first calculating the equations having the least variables. For example, q1 is directly calculable based on the first line of equation set 36, q4 is directly calculable based on the last line of equation 36, and p34 is directly calculable based on the seventh line of equation set 36, based on the previous calculation of p11, p12, p13, p14.

Thereafter, terms p₂₂, p₂₃, p₂₄, p₃₃, p₃₄, q₂ and q₃ may be solved using conventional matrix calculating, such as for example by eliminating of variables by substituting certain variables, so that a only single equation with a single unknown variable remain, thereby enabling calculation of said unknown variable. Thereafter, the value of this calculated variable may inserted into other equations for calculating the remaining variables.

After solving equation set 36, the six remaining elements of P matrix that were p₂₂, p₂₃, p₂₄, p₃₃, p₃₄ and p₄₄ have been calculated along with the four elements of matrix Q, which are q₁, q₂, q₃ and q₄.

Once solution P to the Riccati equation in equation 26 is calculated the linear feedback gains K and K_{I} can be calculated by equation 24, wherein the variable r is set to the previously chosen arbitrary positive number, hence concluding the controller design.

To summarize, the control design process feedback gains K and Ky depend on determining the P matrix based on an arbitrarily chosen positive r as shown in equation 24.

Since P is a symmetric matrix as shown in equation 26, it has 10 unknowns instead of 16 unknowns for a non-symmetric matrix. The first row/column of P can be calculated by comparing the characteristic polynomial of the closed loop system in 28 with denominator of a fourth order transfer function in 35.

The denominator can be solved by solving equation 32 for a chosen point in FIG. 12.

The rest of the elements in P and diagonal matrix Q can then be solved using Riccati equation.

It is worth noting that the controller design process described in this disclosure will also work if matrix Q is not in diagonal form as shown in equation 22. If for instance Q matrix is in a form similar to the one of equation set 36 will be updated accordingly and the system will still have a unique solution if the number of elements in matrix Q are four.

The resulting controller will be stable since it's a LQI feedback controller having a damping ratio ξ set to a positive value, and the integral action guarantees low steady state error. Since the poles are chosen for a critically damped system, the response will reach desired value in short time without overshoot, thereby avoiding need to generate torque from the first electric machine P1 with changing polarity.

Substituting value of p₁₄ in the last equation of equation set 36 from last equation of equation set 35 following equation is obtained:

$$\frac{{q}_{4}}{r} = \frac{{w}_{n}^{8}}{{a}_{4}^{2} {b}^{2}} \qquad ( 37 )$$

Equation 37 shows the relative value between the said arbitrary selected positive weight r on input u and the weight q₄ on the integral error as defined by equation 22 and 23. It can be seen from equation 37 that the relative value depends on a₄ and b, which are physical parameters of the system as defined by equations 13 and 14 and wₙ which depends on the desired performance of the system and is derived by functional requirements as shown in equation 33.

Hence, to fulfil the functional requirements for a particular physical system the relative weighting between q₄ and r must be as defined by equation 37.

It can also be shown that the other weights q₁, q₂ and q₃ relative to r, will also solely depend on physical parameters in matrices A and B from equations 13 and 14 and functional requirements defined using FIG. 12.

So, the LQI control implementation approach described in this disclosure gives controller formulation in terms of physical parameters and functional requirements, hence eliminating the need for large number of controller simulation to tune the controller for desired responses. This will save a lot of transmission calibration work, and also eliminate the risk for errors in the calibration process.

To demonstrate the performance of a controller designed with the presented method, simulations on a 2DOF torsional system representing ICE, dual mass flywheel and first electric machine P1 was performed.

FIG. 13 shows the angular velocities ωₚ and ωₑ during speed synchronization.

From FIG. 12, when the vehicle speed is lower than vᵢₙᵢₜ the ICE 5 and primary side of dog clutch 6a are running at 2000 rpm. At 0.5 seconds in FIG. 13, when the vehicle speed becomes larger than vᵢₙᵢₜ the speed synchronization starts and primary side speed drops to 1500 rpm within 2 seconds, which is time t_{synch} as defined by equation 2.

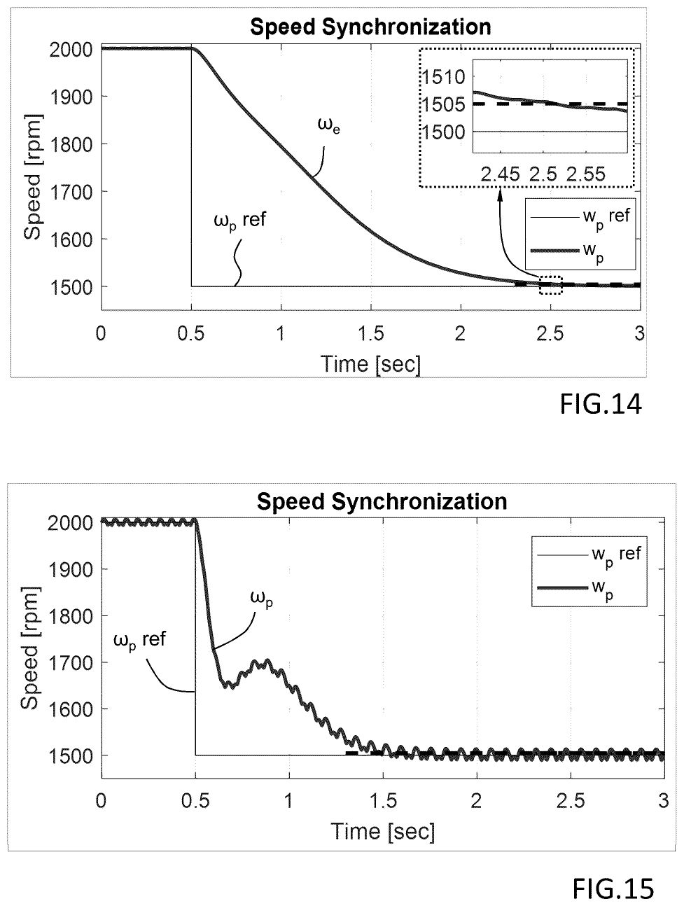

FIG. 14 shows the control of primary side speed ωₚ with the target speed ω_{ref}. The zoomed in view shown by the dotted box shows that ε after time t_{synch} is less than 5 rpm so according to equation 5 the following dog clutch engagement will be without clonk noise.

If the functional requirement of t_{synch} is changed from 2 sec from equation 2 to 1 sec, and the controller is redesigned, the new controller's performance is shown in FIG. 15.

From FIG. 15, it can be seen that the synchronization time requirement of 1 sec is fulfilled but the error after time t_{synch} is not within the limits defined by equation 5.

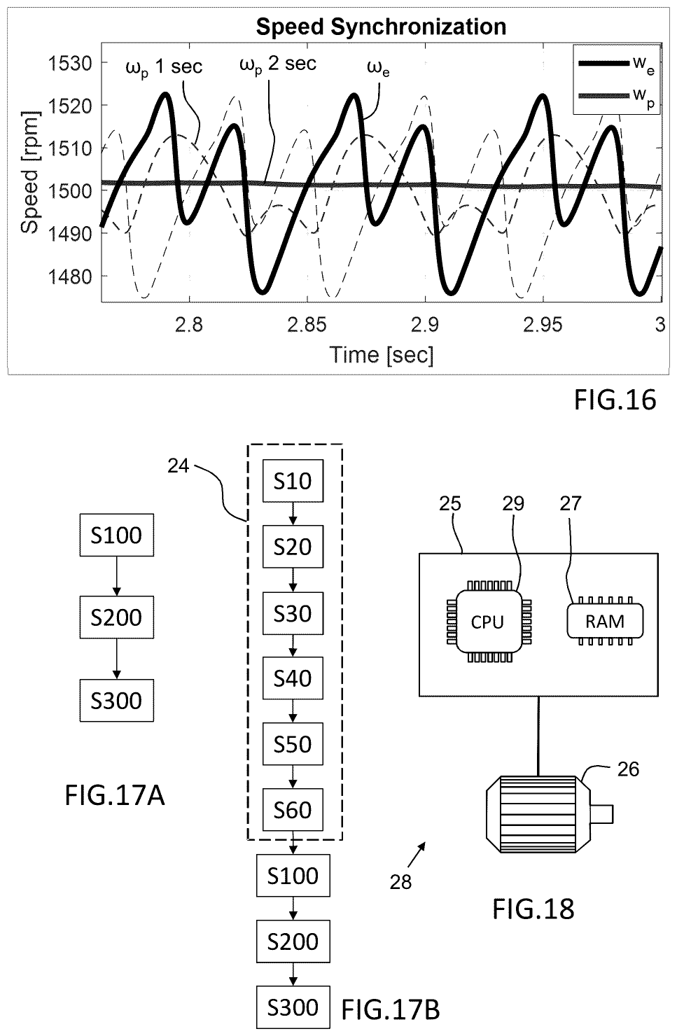

The reason can be seen by investigating the resulting magnitude of q₂ in equation 23, which from equations 22 and 12 is the weight defined for the state Δθ of the system. A high value of q₂ implies that Δθ should be very small. A very small Δθ according to equation 8 means that the vibration isolation between engine and the primary side of dog clutch will be poor. This can be seen by comparing the magnitudes of fluctuations in ωₚ for controller designed for t_{synch} equal to 1 second shown by thin dotted line marked “ωₚ 1 sec” in FIG. 16 and ωₚ for t_{synch} equal to 2 seconds shown by thick line marked with “ωₚ 2 sec” in FIG. 16.

FIG. 16 shows vibration isolation for controllers with different functional requirements with thick dotted lines for t_{synch}=2 sec and thin dashed lines for t_{synch}=1 sec.

From FIG. 16, it can be seen that fluctuations in ωₑ under the influence of the disturbance T_{ICE} is same for both controllers.

For the controller designed using the approach described the value of q₂ for t_{synch}=1 sec is 170 times more than that for t_{synch}=2 sec and hence the poor vibration isolation and unfulfillment of error after time t_{synch} in FIG. 15 as compared to FIG. 14.

For the particular problem of speed synchronization in the hybrid powertrain described in this example embodiment of the disclosure, it is not an issue that the synchronization time is long because the speed synchronization is not time critical. So by decreasing vᵢₙᵢₜ in FIG. 2, the t_{synch} can be increased according to equation 1 to a level where the noise requirement is fulfilled e.g. t_{synch} being equal to 2 sec.

Alternatively a non-diagonal form of Q in equation 23 can be calculated by a iterative method using desired close loop poles. The desired closed loop poles can be obtained from the method explained above.

The calibration method and corresponding dynamic physical system of the present disclosure have been described above in detail with reference to FIGS. 1A-16 and in the context of the specific implementation of controlling clutch engagement process of a dog clutch. However, as mentioned earlier in the text, the calibration method and corresponding dynamic physical system of the present disclosure is not restricted to this example embodiment but may be advantageously used also in other technical implementations having a controller for controlling a controllable device.

Consequently, with reference to FIG. 17A, the present disclosure relates to a general method for calibrating the feedback gains K of an LQI controller implemented in an electronic control unit operatively connected for controlling operation of a physical electric or electro-mechanical device of a dynamic physical system, in particular a vehicle power train, wherein the LQI controller is based on an augmented State Space model having the following form:

$$[ \begin{matrix}\dot{x} \\ ε\end{matrix} ] = {A}_{aug} x + {B}_{aug} u + [ \begin{matrix}0 \\ 1\end{matrix} ] ref$$

$$y = {C}_{aug} [ \begin{matrix}x \\ ε\end{matrix} ]$$

$${A}_{aug} = [ \begin{matrix}A & 0 \\ - C & 0\end{matrix} ] , {B}_{aug} = {[ \begin{matrix}B & 0\end{matrix} ]}^{T} , {C}_{aug} = [ \begin{matrix}C & 0\end{matrix} ]$$

wherein the augmented State Space model is based on the following State Space model representing the physical system:

$$\begin{matrix}\dot{x} = Ax + Bu \\ y = Cx\end{matrix}$$

where x is control system state vector, ε is control system tracking error, u is control system input, ref is control system target references value, y is control system output, and A, B, C represent matrices derived from a mathematical model of the dynamic physical system, and wherein the method of calibrating the LQI controller comprises a first step S100 of obtaining values of various physical parameters of the dynamic system. The method further comprises a second step S200 of inserting the obtained values of the physical parameters into predetermined equations for calculating numerical values of the individual terms of a P matrix, wherein the P matrix is the solution to the Algebraic Riccati equation, and wherein said equations include the physical parameters of the system. Finally, the method comprises a third step S300 of calculating new feedback gains for the LQI controller based on the matrix equation

$$K = {r}^{- 1} {B}_{aug}^{T} P ,$$

based on an arbitrarily chosen positive value of r, wherein the terms of the K matrix corresponds to the feedback gains.

Thereby, the LQI controller may be calibrated by simply applying the new feedback gains.

The physical parameters may be any type of parameters associated with a physical system, such as for example inertia, damping constant, spring constant, weight, friction, conductivity, viscosity, etc., depending on the type of system and controllable device.

Furthermore, the method may also include the step of calculating numerical values of the individual terms of a B matrix, because also the values of the terms of the B matrix is required for calculating the feedback gains.

In some example embodiments, the P matrix is a diagonal matrix having the following form:

$$P = [ \begin{matrix}{p}_{11} & {p}_{12} & ⋯ & {p}_{1 n} \\ {p}_{12} & {p}_{22} & ⋯ & {p}_{2 n} \\ ⋯ & ⋯ & ⋯ & {p}_{3 n} \\ {p}_{1 n} & {p}_{2 n} & ⋯ & {p}_{nn}\end{matrix} ] .$$

In some example embodiments, each of the equations for calculating the terms of the P matrix is a function of not more than constants, obtainable physical parameters of the dynamic system, other terms of the P matrix, and terms of the Q matrix.

In some example embodiments, the physical parameters of the dynamic system are obtained by {\displaystyle \det(\lambda I-A)=0} manually by a user that is measuring, detecting or estimating the values of the physical parameters of the dynamic system; and/or by the electronic control unit that automatically conducts measurements, detects or estimates the values of the physical parameters of the dynamic system.

In some example embodiments, the step of calculating feedback gains K for the LQI controller is free from matrix calculation involving a numerical representation of matrix A of the dynamic physical system.

In some example embodiments, the method further includes a setup phase of the LQI controller. The setup phase is generally performed in connection with designing of the LQI controller for the physical system, and this before said calibration of the feedback gains K. With reference to FIG. 17B, the setup phase may include a first step S10 of determining the terms of the matrices A, B and C in form of ones, zeros, and equations having physical constants of the system as expression, while omitting the step of transforming the matrices A, B and C to a controllable canonical form. A second step S20 of determining a feedback control system having an Integral Linear Quadratic (LQI) controller that outputs system input u that minimizes the criteria J where

$$J = {\int }_{0}^{∞} [ \begin{matrix}{x}^{T} & ε\end{matrix} ] Q [ \begin{matrix}{x}^{T} & ε\end{matrix} ] + {u}^{T} ru ,$$

feedback controller includes said feedback gains. The setup phase may further include a third step S30 of determining the characteristic equation of the control system, a fourth step S40 of determining the transfer function of the control system, a fifth step S50 of determining the location of the poles of the transfer function, and a sixth step S60 of deriving equations for the terms of each of the Q and P matrix using the Algebraic Riccati Equation:

$${PA}_{aug} + {A}_{aug}^{T} P - {PB}_{aug} {r}^{- 1} {B}_{aug}^{T} P + Q = 0.$$

Setting a matrix in a controllable canonical form means transforming for example the A matrix, such that the A matrix has each of the denominator coefficients of the transfer function of the closed loop system, i.e. the coefficients of the characteristic polynomial, showing up negated and in reverse order in the bottom row of the A matrix.

In some example embodiments, the characteristic equation of the closed loop control system has the following form:

$$det ( sI - {A}_{aug} + {B}_{aug} {r}^{- 1} {B}_{aug}^{T} P ) = 0 .$$

In some example embodiments, the equations for the terms of the P matrix are also derived based on the denominator of the transfer function in combination with the coefficients and constant terms of the characteristic polynomial of the closed loop system.

In some example embodiments, the method further comprises determining the location of the poles of the transfer function by Laplace-inverse-transforming the denominator of the transfer function and inputting the values of any point of a step response of the transfer function G(s), thereby enabling calculation of the natural frequency wₙ, which gives the location of the poles of the transfer function.

In some example embodiments, the transfer function includes a damping ratio ζ, and wherein the damping ratio ζ is selected to be equal to about 1.0, or exactly 1.0.

In some example embodiments, the Q matrix is a diagonal weight matrix having the following form:

$$Q = [ \begin{matrix}{q}_{1} & … & 0 \\ ⋮ & ⋱ & ⋮ \\ 0 & … & {q}_{n}\end{matrix} ] .$$

In some example embodiments, the step of omitting transformation of one or more of the matrices A, B and C to a controllable canonical form enables the terms of matrices A, B and C to retain their original expressions as functions of detectable system parameters, such that the equations for calculating the terms of the P matrix may be expressed in terms of as functions of detectable system parameters, thereby enabling computational-easy calculation of new feedback gains suitable for implementation in a low-computational system, such as in particular a vehicle system.

In addition, with reference to FIG. 18, the present disclosure also relates to a general dynamic physical system 28, in particular a vehicle power train, comprising a physical electric or electro-mechanical device 26, such as for example an electric motor, an actuator or the like. The dynamic physical system 28 further comprises an electronic control unit 25 operatively connected to the physical electric or electro-mechanical device 26, wherein the electronic control unit 25 comprises a CPU 29 suitable for executing a code for implementing a LQI controller configured for controlling operation of the physical electric or electro-mechanical device 26, wherein the LQI controller is based on an augmented State Space model representing the dynamic physical system, wherein the augmented State Space model may have the following form:

$$[ \begin{matrix}\dot{x} \\ ε\end{matrix} ] = {A}_{aug} x + {B}_{aug} u + [ \begin{matrix}0 \\ 1\end{matrix} ] ref$$

$$y = {C}_{aug} [ \begin{matrix}x \\ ε\end{matrix} ]$$

$${A}_{aug} = [ \begin{matrix}A & 0 \\ - C & 0\end{matrix} ] , {B}_{aug} = {[ \begin{matrix}B & 0\end{matrix} ]}^{T} , {C}_{aug} = [ \begin{matrix}C & 0\end{matrix} ]$$

wherein the augmented State Space model is based on the following State Space model representing the physical system:

$$\dot{x} = Ax + Bu$$

$$y = Cx$$

wherein x is control system state vector, ε is control system tracking error, u is control system input, ref is control system target references value, y is control system output, and A, B, C represent matrices derived from a mathematical model of the dynamic physical system. The electronic control unit 25 further comprises a data memory 27 including predetermined equations for calculating numerical values of the individual terms of a P matrix, wherein the P matrix is the solution to the Algebraic Riccati equation, and wherein said equations include the physical parameters of the system. The feedback gains of the LQI controller is configured to be calibrated by: obtaining values of various physical parameters of the dynamic system; inserting the obtained values of the physical parameters into the predetermined equations for calculating numerical values of the individual terms of a P matrix; and calculating new feedback gains for the LQI controller based on the matrix equation

$$K = {r}^{- 1} {B}_{aug}^{T} P ,$$

based on an arbitrarily chosen positive value of r, wherein the terms of the K matrix corresponds to the feedback gains.

In some example embodiments, the physical electric or electro-mechanical device 26 of the dynamic physical system is an actuator, a motor, a pump, a light or RF source, or an electro-dynamic device.

In some example embodiments, the dynamic physical system 28 is a vehicle system, specifically a vehicle power train system, and more specifically a vehicle power train system having a first electric machine P1 operatively connected to a first part 6a of a dog clutch 6, wherein the electronic controller 25 controls the rotational speed of the first part 6a of the dog clutch 6 for speed synchronising with a second part 6b of the dog clutch 6, such that the first and second dog clutch parts 6a, 6b can be shifted from disengaged state to engaged state in a smooth and noise-free manner.

In some example embodiments, the vehicle power train system is implemented in a hybrid electric vehicle having a combustion engine 5 drivingly connected to the first electric machine P1, and second electric machine P2 drivingly connected to the second part 6b of the dog clutch 6, and wherein shifting of the first and second dog clutch parts 6a, 6b from disengaged state to mutually engaged state results in switching from serial to parallel operation of the hybrid electric vehicle.

The disclosure also relates to a hybrid electric vehicle, wherein a shift of the first and second dog clutch parts from disengaged state to mutually engaged state is configured to switch operation of the hybrid electric vehicle from serial to parallel operation.

The present disclosure has been presented above with reference to specific embodiments. However, other embodiments than the above described are possible and within the scope of the disclosure.

Specifically, the method for calibrating the feedback gains K of the LQI controller according to the present disclosure may be applied to LQI controllers used for controlling virtually any type of technical system, in particular systems requiring noise rejection, e.g. control system having measurement and process noise with respect to one or more of the control parameters.

In other words, the calibration method is applicable to all types of technical systems, such as for example, but not restricted to, road vehicles, avionics, marine vessels, rail bound vehicles, magnetic elevation train, energy power generators, industry manufacturing processes, etc. With respect to vehicles, the calibration method may for example be applied to a LQI controller that is arranged to control a vehicle clutch, a vehicle speed controller, a vehicle stability controller, vehicle motor controller, a vehicle battery thermal controller, a vehicle battery charging controller, a vehicle DC/DC controller, a vehicle suspension controller, a vehicle autonomous drive controller, a vehicle platooning controller, etc.

Different method steps than those described above, performing the method by hardware or software, may be provided within the scope of the disclosure.

The methods disclosed herein may be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Thus, according to an exemplary embodiment, there is provided a non-transitory computer-readable storage medium storing one or more programs configured to be executed by one or more processors of the dynamic physical system 28 having the LQI controller, the one or more programs comprising instructions for performing the method according to any one of the above-discussed embodiments. Alternatively, according to another exemplary embodiment a cloud computing system can be configured to perform any of the method aspects presented herein. The cloud computing system may comprise distributed cloud computing resources that jointly perform the method aspects presented herein under control of one or more computer program products. Moreover, the processor may be connected to one or more communication interfaces and/or sensor interfaces for receiving and/transmitting data with external entities such as e.g. sensors arranged on the vehicle surface, an off-site server, or a cloud-based server.

The processor(s) of the dynamic physical system 28 may be or include any number of hardware components for conducting data or signal processing or for executing computer code stored in memory. The system may have an associated memory, and the memory may be one or more devices for storing data and/or computer code for completing or facilitating the various methods described in the present description. The memory may include volatile memory or non-volatile memory. The memory may include database components, object code components, script components, or any other type of information structure for supporting the various activities of the present description. According to an exemplary embodiment, any distributed or local memory device may be utilized with the systems and methods of this description. According to an exemplary embodiment the memory is communicably connected to the processor (e.g., via a circuit or any other wired, wireless, or network connection) and includes computer code for executing one or more processes described herein.

It will be appreciated that the above description is merely exemplary in nature and is not intended to limit the present disclosure, its application or uses. While specific examples have been described in the specification and illustrated in the drawings, it will be understood by those of ordinary skill in the art that various changes may be made and equivalents may be substituted for elements thereof without departing from the scope of the present disclosure or the claims. Furthermore, modifications may be made to adapt a particular situation or material to the teachings of the present disclosure without departing from the essential scope thereof.

Therefore, it is intended that the present disclosure not be limited to the particular examples illustrated by the drawings and described in the specification as the best mode presently contemplated for carrying out the teachings of the present disclosure, but that the scope of the present disclosure will include any embodiments falling within the foregoing description and the appended claims. Reference signs mentioned in the claims should not be seen as limiting the extent of the matter protected by the claims, and their sole function is to make claims easier to understand.

### REFERENCE SIGNS

1. Car
2. Propulsion power source
3. Wheels
4. Powertrain
5. Internal combustion engine
6. Dog clutch
7. Battery
8. Transmission
9. Charging flow
10. Discharging flow
11. Dual mass flywheel
12. Actuation mechanism
13. Sleeve
14. Hub
15. Splines connection
16. Dog teeth of hub
17. Dog teeth of sleeve
18. Dog teeth of secondary side
19. Transmission gear
20. Shifter motor
21. Shifter rail
22. Shift finger
23. Shift fork
24. Setup phase
25. Electronic control unit
26. Physical controllable device
27. Data memory
28. Physical system
29. CPU
P1. First electric motor
P2. Second electric motor

What is claimed is:

1. A method for calibrating the feedback gains K of an LQI controller implemented in an electronic control unit operatively connected for controlling operation of a physical electric or electro-mechanical device of a dynamic physical system, in particular a vehicle powertrain, wherein the LQI controller is based on an augmented State Space model having the following form:
$$[ \begin{matrix}\dot{x} \\ ε\end{matrix} ] = {A}_{aug} x + {B}_{aug} u + [ \begin{matrix}0 \\ 1\end{matrix} ] ref$$
$$y = {C}_{aug} [ \begin{matrix}x \\ ε\end{matrix} ]$$
$${A}_{aug} = [ \begin{matrix}A & 0 \\ - C & 0\end{matrix} ] , {B}_{aug} = {[ \begin{matrix}B & 0\end{matrix} ]}^{T} , {C}_{aug} = [ \begin{matrix}C & 0\end{matrix} ]$$
wherein the augmented State Space model is based on the following State Space model representing the physical system:
$$\dot{x} = Ax + Bu$$
$$y = Cx$$
wherein x is control system state vector, ε is control system tracking error, u is control system input, ref is control system target references value, y is control system output, and A, B, C represent matrices derived from a mathematical model of the dynamic physical system,
wherein the method of calibrating the LQI controller comprises:
obtaining values of various physical parameters of the dynamic physical system;
inserting the obtained values of the physical parameters into predetermined equations for calculating numerical values of the individual terms of a P matrix, wherein the P matrix is the solution to the Algebraic Riccati equation, and wherein said equations include the physical parameters of the system; and
calculating new feedback gains for the LQI controller based on the matrix equation
$$K = {r}^{- 1} {B}_{aug}^{T} P ,$$
based on an arbitrarily chosen positive value of r, wherein the terms of the K matrix corresponds to the feedback gains.

2. The method according to claim 1, wherein each of the equations for calculating the terms of the P matrix is a function of not more than constants, obtainable physical parameters of the dynamic physical system, other terms of the P matrix, and terms of the Q matrix.

3. The method according to claim 1, wherein the physical parameters of the dynamic system are obtained:
manually by a user that is measuring, detecting or estimating the values of the physical parameters of the dynamic system, and/or
by the electronic control unit that automatically conducts measurements, detects or estimates the values of the physical parameters of the dynamic system.

4. The method according to claim 1, further comprising a setup phase of the LQI controller that is performed before said calibration of the feedback gains K, wherein the setup phase includes:
determining the terms of the matrices A, B and C in form of ones, zeros, and equations having physical constants of the system as expression, while omitting the step of transforming the matrices A, B and C to a controllable canonical form,
determining a feedback control system having an Integral Linear Quadratic (LQI) controller that outputs system input u that minimizes the criteria J where
$$J = {\int }_{0}^{∞} [ \begin{matrix}{x}^{T} & ε\end{matrix} ] Q [ \begin{matrix}{x}^{T} & ε\end{matrix} ] + {u}^{T} ru$$
wherein Q is matrix and r is a scalar, and wherein the LQI feedback controller includes said feedback gains,
determining the characteristic equation of the control system,
determining the transfer function of the control system, and subsequently determining the location of the poles of the transfer function,
deriving equations for the terms of each of the Q and P matrix using the Algebraic Riccati Equation:
$${PA}_{aug} + {A}_{aug}^{T} P - {PB}_{aug} {r}^{- 1} {B}_{aug}^{T} P + Q = 0 .$$

5. The method according to claim 4, wherein equations for the terms of the P matrix are also derived based on the denominator of the transfer function in combination with the coefficients and constant terms of the characteristic polynomial of the closed loop system.

6. The method according to claim 1, further comprising determining the location of the poles of the transfer function by Laplace-inverse-transforming the denominator of the transfer function and inputting the values of any point of a step response of the transfer function G(s), thereby enabling calculation of the natural frequency wₙ, which gives the location of the poles of the transfer function.

7. The method according to claim 4, wherein the step of omitting transformation of the matrices A, B and C to a controllable canonical form enables the terms of matrices A, B and C to retain their original expressions as functions of detectable system parameters, such that the equations for calculating the terms of the P matrix may be expressed in terms of as functions of detectable system parameters, thereby enabling computational-easy calculation of new feedback gains suitable for implementation in a low-computational system, such as in particular a vehicle system.

8. The method according to claim 1, wherein the dynamic physical system is a vehicle system, specifically a vehicle power train system, and more specifically a vehicle power train system having a first electric machine operatively connected to a first part of a dog clutch, wherein the electronic control unit controls the rotational speed of the first part of the dog clutch for speed synchronising with a second part of the dog clutch, such that the first and second dog clutch parts can be shifted from disengaged state to engaged state in a smooth and noise-free manner.

9. The method according to claim 1, wherein the predetermined equations for calculating numerical values of the individual terms of the P matrix include at least one parameter defining a functional requirement of the physical system.

10. A dynamic physical system, in particular a vehicle power train, comprising:
a physical electric or electro-mechanical device, and
an electronic control unit operatively connected to the physical electric or electro-mechanical device,
wherein the electronic control unit comprises an LQI controller configured for controlling operation of the physical electric or electro-mechanical device, wherein the LQI controller is based on an augmented State Space model having the following form:
$$[ \begin{matrix}\dot{x} \\ ε\end{matrix} ] = {A}_{aug} x + {B}_{aug} u + [ \begin{matrix}0 \\ 1\end{matrix} ] ref$$
$$y = {C}_{aug} [ \begin{matrix}x \\ ε\end{matrix} ]$$
$${A}_{aug} = [ \begin{matrix}A & 0 \\ - C & 0\end{matrix} ] , {B}_{aug} = {[ \begin{matrix}B & 0\end{matrix} ]}^{T} , {C}_{aug} = [ \begin{matrix}C & 0\end{matrix} ]$$
wherein the augmented State Space model is based on the following State Space model representing the physical system:
$$\dot{x} = Ax + Bu$$
$$y = Cx$$
wherein x is control system state vector, ε is control system tracking error, u is control system input, ref is control system target references value, y is control system output, and A, B, C represent matrices derived from a mathematical model of the dynamic physical system,
wherein the electronic control unit further comprises a data memory including predetermined equations for calculating numerical values of the individual terms of a P matrix, wherein the P matrix is the solution to the Algebraic Riccati equation, and wherein said equations include the physical parameters of the system,
wherein the feedback gains of the LQI controller is configured to be calibrated by:
obtaining values of various physical parameters of the dynamic system;
inserting the obtained values of the physical parameters into the predetermined equations for calculating numerical values of the individual terms of a P matrix; and
calculating new feedback gains for the LQI controller based on the matrix equation
$$K = {r}^{- 1} {B}_{aug}^{T} P ,$$
based on an arbitrarily chosen positive value of r, wherein the terms of the K matrix corresponds to the feedback gains.

11. The dynamic physical system according to claim 10, wherein each of the equations for calculating the terms of the P matrix is a function of not more than constants, obtainable physical parameters of the dynamic system, other terms of the P matrix, and terms of the Q matrix.

12. The dynamic physical system according to claim 10,
wherein the data memory further includes the terms of the matrices A, B and C in form of ones, zeros, and equations having physical constants of the system as expression, wherein the matrices A, B and C have not been transformed into a controllable canonical form,
wherein the LQI controller is configured to output a control system input u that minimizes the criteria J where
$$J = {\int }_{0}^{∞} [ \begin{matrix}{x}^{T} & ε\end{matrix} ] Q [ \begin{matrix}{x}^{T} & ε\end{matrix} ] + {u}^{T} ru$$
and where Q is matrix and r is a scalar,
wherein the equations for the terms of the Q matrix is stored in the data memory.

13. The dynamic physical system according to claim 10, wherein the matrices A, B and C stored in the data memory have not been transformed into a controllable canonical form, and the terms of matrices A, B and C are therefore retained in their original expressions as functions of detectable system parameters, such that the equations for calculating the terms of the P matrix may be expressed in terms of as functions of detectable system parameters, thereby enabling computational-easy calculation of new feedback gains suitable for implementation in a low-computational system, such as in particular a vehicle system.

14. The dynamic physical system according to claim 10, wherein the physical electric or electro-mechanical device of the dynamic physical system is an actuator, a motor, a pump, a light or RF source, or an electro-dynamic device.

15. The dynamic physical system according to claim 10, wherein the dynamic physical system is a vehicle system, specifically a vehicle power train system, and more specifically a vehicle power train system having a first electric machine operatively connected to a first part of a dog clutch, wherein the electronic control unit is configured to control the rotational speed of the first part of the dog clutch for speed synchronising with a second part of the dog clutch, such that the first and second dog clutch parts can be shifted from disengaged state to engaged state in a smooth and noise-free manner.

16. The dynamic physical system according to claim 10, wherein the predetermined equations for calculating numerical values of the individual terms of a P matrix also include at least one parameter defining a functional requirement of the physical system,
wherein said feedback gains of the LQI controller is configured to be calibrated by:
obtaining values of various physical parameters of the dynamic system and at least one value of a parameter defining the functional requirement of the physical system;
inserting the obtained values of the physical parameters and functional requirement into the predetermined equations for calculating numerical values of the individual terms of a P matrix; and subsequently
calculating new feedback gains for the LQI controller based on the matrix equation
$$K = {r}^{- 1} {B}_{aug}^{T} P .$$

17. A hybrid electric vehicle having a vehicle power train system including:
a dog clutch having first and second parts,
a combustion engine drivingly connected to the first electric machine that is operatively connected to the first part of the dog clutch, and
a second electric machine drivingly connected to the second part of the dog clutch, and
a dynamic physical system according to claim 10.
